(19) United States
(12) Patent Application Publication
(10) Pub. No.: US 2026/0338133 A1
(43) Pub. Date: Oct. 29, 2026

(54) CLOSED LOOP FLUID CYCLE FOR EXPANSION ENGINE

(71) Applicant: Phoenix Eng Corp., Miami, FL (US)

(72) Inventor: Ariel E. Saric Fourmentel, Buenos Aires (AR)

(21) Appl. No.: 19/654,033

(22) Filed: Apr. 21, 2026

Related U.S. Application Data
(60) Provisional application No. 63/796,675, filed on Apr. 29, 2025.

(51) Int. Cl. F02G 1/055; C09K 5/04; F01K 25/08

(52) U.S. Cl. CPC F02G 1/055; C09K 5/04; F01K 25/08; F02G 2254/45; F02G 2290/00

(57) ABSTRACT

A fluid composition includes water, such as distilled water, and a various additional components for lubrication and regulation. An engine system includes an engine having an expansion chamber, and a fluid pathway fluidly connected to the expansion chamber and defining a closed loop fluid cycle. The fluid composition is disposed in the closed loop fluid cycle. The fluid pathway directs the fluid composition to the expansion chamber and from the expansion chamber.

### CROSS-REFERENCE TO RELATED APPLICATIONS

This patent application claims priority to and the benefit of U.S. Provisional Patent Application No. 63/796,675, filed on Apr. 29, 2025, the contents of which are incorporated herein by reference in their entirety.

### TECHNICAL FIELD

This disclosure relates to engine systems, such as fluid systems connected to an engine.

### BACKGROUND

Internal combustion engines rely on the combustion and consumption of fuel, such as hydrocarbons in the form of gasoline, diesel, or natural gas, to provide a mechanical output to an engine. Traditional engine fluids often require frequent replacements and can be inefficient in terms of energy transfer.

### SUMMARY

In some aspects, a fluid comprises water and a lubricant.

These, and other aspects, can include one or more of the following features. The water can include distilled water. The lubricant can be one or more of mineral oil, polyalphaolefins (PAO), an ester, group III base oils, and/or hydrogenated vegetable esters. The fluid can include one or more or all of the following: (i) a volatility regulator and nucleation enhancer selected from the group consisting of: isopropyl alcohol, ethanol, n-propanol, and t-butanol; (ii) a heat capacity enhancer and cavitation stabilizer selected from the group consisting of: monoethylene glycol, propylene glycol, diethylene glycol, and triethylene glycol; (iii) a polar interface modulator and micelle contributor selected from the group consisting of: oleic acid, ricinoleic acid, stearic acid, a trimethylolpropane ester, and/or a pentaerythritol ester; (iv) a viscosity stabilizer and thermal damping modifier selected from the group consisting of: glycerol, sorbitol, PEG-400, and a polyglycerol; (v) a non-ionic surfactant selected from the group consisting of: sorbitan monooleate, tween 80, modified lecithin, and an ethoxylated non-ionic ester; (vi) a vapor phase accelerator selected from the group consisting of: methyl ethyl ketone (MEK), acetone, methyl isobutyl ketone (MIBK), ethyl acetate, and diethyl ether; and (vii) an antioxidant comprising hindered phenols and phosphites. For example, the fluid can include at least one of (i)-(vii), at least two of (i)-(vii), at least three of (i)-(vii), at least four of (i)-(vii), at least five of (i)-(vii), at least six of (i)-(vii), or all of (i)-(vii). The lubricant can include light mineral oil. The volatility regulator and nucleation enhancer can include isopropyl alcohol. The heat capacity enhancer and cavitation stabilizer can include monoethylene glycol. The polar interface modulator and micelle contributor can include oleic acid. The viscosity stabilizer and thermal damping modifier can include glycerol. The non-ionic surfactant can include sorbitan monooleate. The vapor phase accelerator can include methyl ethyl ketone (MEK). The fluid can include about 55 wt. % to about 70 wt. % water. The fluid can include about 60 wt. % water. The fluid can include about 2 wt. % to 10 about wt. % of the lubricant. The fluid can include about 6 wt. % of the lubricant. The fluid can include about 10 wt. % to about 22 wt. % (i). The fluid can include about 14 wt. % of the volatility regulator and nucleation enhancer. The fluid can include about 4 wt. % to about 12 wt. % of the heat capacity enhancer and cavitation stabilizer. The fluid can include about 8 wt. % of the heat capacity enhancer and cavitation stabilizer. The fluid can include about 2 wt. % to about 6 wt. % of the polar interface modulator and micelle contributor. The fluid can include about 4 wt. % of the polar interface modulator and micelle contributor. The fluid can include about 1 wt. % to about 5 wt. % of the viscosity stabilizer and thermal damping modifier. The fluid can include about 3 wt. % of the viscosity stabilizer and thermal damping modifier. The fluid can include about 1 wt. % to about 4 wt. % of the non-ionic surfactant. The fluid can include about 2 wt. % of the non-ionic surfactant. The fluid can include about 1 wt. % to about 5 wt. % of the vapor phase accelerator. The fluid can include about 2 wt. % of the vapor phase accelerator. The fluid can include about 0.001 wt. % to about 1 wt. % of the antioxidant. The fluid can include about 0.3 wt. % of the antioxidant.

In certain aspects, an engine system includes an engine including an expansion chamber, and a fluid pathway fluidly connected to the expansion chamber and defining a closed loop fluid cycle. The fluid pathway directs the fluid of any aspect to the expansion chamber and from the expansion chamber, and the fluid is disposed in the fluid pathway and comprising distilled water.

These, and other aspects, can include one or more of the following features. The engine system can include a fluid pump fluidly connected to the fluid cycle, where the fluid pump pressurizes the fluid in the fluid cycle upstream of the expansion chamber to a minimum pressure threshold. The minimum pressure threshold can be 2,000 bar. The engine can include an injector disposed at least partially within the expansion chamber to inject a portion of the fluid into the expansion chamber. The injector can include an activator in fluid communication with the fluid in the injector, where the activator causes the fluid to transition from liquid phase to gas phase. The activator can include an induction coil to heat the fluid to its gas phase. The engine system can include a recirculation system fluidly connected to the fluid pathway and including a condenser to cause the fluid to transition to liquid phase. The recirculation system can be fluidly connected to the engine to supply the fluid in liquid phase to the engine. The engine can include multiple cylinders and a multiple pistons disposed in the cylinders, where the multiple pistons and multiple cylinders define a plurality of expansion chambers including the first-mentioned expansion chamber, and the multiple pistons to translate within respective cylinders.

Certain aspects encompass a method for operating an engine. The method includes receiving, at an expansion chamber of an engine, a fluid according to any aspect from a fluid pathway. The method further includes causing the fluid to transition from liquid phase to gas phase in the expansion chamber, receiving, at a condenser fluidly connected to the expansion chamber, the fluid from the expansion chamber, and converting, at the condenser, the fluid into liquid phase.

These, and other aspects, can include one or more of the following features. The fluid pathway can define a closed loop fluid cycle, where the method includes recirculating the fluid from the condenser toward the expansion chamber of the engine. The method can include pressurizing, with a fluid pump fluidly connected to the fluid pathway upstream of the expansion chamber, the fluid in the fluid pathway to a minimum pressure threshold. Receiving the fluid at the expansion chamber can include injecting, with an injector disposed at least partially within the expansion chamber, a portion of the fluid into the expansion chamber. The injector can include an activator in fluid communication with the fluid in the injector, and causing the fluid to transition from liquid phase to gas phase includes causing, with the activator, the fluid to transition from liquid phase to gas phase. The activator can include an induction coil, and causing the fluid to transition from liquid phase to gas phase can include heating, with the induction coil, the fluid to its gas phase.

In some aspects, an engine system includes an engine including a chamber defined at least partially by a cylinder and a piston, and an injector at least partially disposed within the chamber. The injector injects the fluid of any aspect into the chamber and causes a phase transition of the fluid from liquid phase to gas phase.

These, and other aspects, can include one or more of the following features. The engine system can include a closed loop fluid cycle, where the fluid is disposed in the closed loop fluid cycle, and the closed loop fluid cycle supplies the fluid to the injector, receives the fluid from the chamber, and recirculates the fluid back to the injector.

This disclosure describes engine systems including a fluid pathway to direct fluid to an engine, where the fluid pathway is a closed loop fluid cycle that recirculates the fluid through the engine. The fluid includes a solution of distilled water that expands upon vaporization, where this expansion provides mechanical output to the engine, and the fluid is then condensed and recirculated for use in the engine again.

In some aspects, an engine system includes an engine including an expansion chamber, a fluid pathway fluidly connected to the expansion chamber and defining a closed loop fluid cycle, and a fluid disposed in the fluid pathway. The fluid pathway to direct a fluid to the expansion chamber and from the expansion chamber, and the fluid disposed including distilled water.

These, and other aspects, can include one or more of the following features. The engine system can further include a fluid pump fluidly connected to the fluid cycle, the fluid pump to pressurize the fluid in the fluid cycle upstream of the expansion chamber to a minimum pressure threshold. The minimum pressure threshold can be 2,000 bar. The engine can include an injector disposed at least partially within the expansion chamber to inject a portion of the fluid into the expansion chamber. The injector can include an activator in fluid communication with the fluid in the injector, the activator to cause the fluid to transition from liquid phase to gas phase. The activator can include an induction coil to heat the fluid to its gas phase. The fluid can include the distilled water in a concentration of at least 55% by weight. The fluid can include about 60% distilled water. A remainder of the fluid can include at least one of a fatty acid component, an alcohol component, or a hydrocarbon component. The remainder of the fluid can include the fatty acid component, the alcohol component, and the hydrocarbon component. The engine system can further include a recirculation system fluidly connected to the fluid pathway and including a condenser to cause the fluid to transition to liquid phase. The recirculation system can be fluidly connected to the engine to supply the fluid in liquid phase to the engine. The engine can include multiple cylinders, each cylinder with a corresponding piston disposed in the respective cylinder, where the pistons and cylinders define multiple expansion chambers including the first-mentioned expansion chamber, and the pistons translate within their respective cylinders.

Certain aspects of the disclosure encompass a method for operating an engine. The method includes receiving, at an expansion chamber of an engine, a fluid from a fluid pathway, where the fluid includes distilled water. The method further includes causing the fluid to transition from liquid phase to gas phase in the expansion chamber, receiving, at a condenser fluidly connected to the expansion chamber, the fluid from the expansion chamber, and converting the fluid into liquid phase at the condenser.

These, and other aspects, can include one or more of the following features. The fluid pathway can define a closed loop fluid cycle, and the method can further include recirculating the fluid from the condenser toward the expansion chamber of the engine. The method can include pressurizing, with a fluid pump fluidly connected to the fluid pathway upstream of the expansion chamber, the fluid in the fluid pathway to a minimum pressure threshold. Receiving the fluid at the expansion chamber can include injecting, with an injector disposed at least partially within the expansion chamber, a portion of the fluid into the expansion chamber. The injector can include an activator in fluid communication with the fluid in the injector, and causing the fluid to transition from liquid phase to gas phase can include causing, with the activator, the fluid to transition from liquid phase to gas phase. The activator can include an induction coil, and causing the fluid to transition from liquid phase to gas phase can include heating, with the induction coil, the fluid to its gas phase.

In some aspects, an engine system includes an engine including a chamber defined at least partially by a cylinder and a piston, an injector at least partially disposed within the chamber, where the injector injects a fluid into the chamber and causes a phase transition of the fluid from liquid phase to gas phase, and the fluid includes distilled water.

These, and other aspects, can include one or more of the following features. The engine system can include a closed loop fluid cycle, where the fluid is disposed in the closed loop fluid cycle. The closed loop fluid cycle supplies the fluid to the injector, receives the fluid from the chamber, and recirculates the fluid back to the injector. The fluid can include the distilled water in a concentration of between 55% and 70% by weight.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic view of an example engine system including an engine and an engine control system usable with aspects of the present disclosure.

FIG. 2 is a cross-sectional front view of an example injector that can be used in the example engine system of FIG. 1.

FIG. 3 is a schematic, partial cross-sectional front view of an example coalescing filter and compressor that can be used in a recirculation system of the example engine system of FIG. 1.

FIG. 4 is a schematic, partial cross-sectional front view of an example venturi system that can be used in a recirculation system of the example engine system of FIG. 1.

FIG. 5 is a flowchart describing an example method for operating an engine, such as performed by the example engine system of FIG. 1.

Like reference numbers and designations in the various drawings indicate like elements.

### DETAILED DESCRIPTION

This disclosure describes engine systems with a closed loop fluid cycle for circulating a fluid through the engine system, and fluids for use in the engine systems. The fluid is directed to an engine, where the fluid is converted from liquid phase to gas phase (e.g., vaporized) and rapidly expands, imparting a force against a surface to generate a mechanical output of the engine. The fluid is then directed to a condenser, where it is returned to a liquid phase and recirculated for use in the engine again. The fluid used in the closed loop fluid cycle is a water-based solution made up of mostly distilled water (e.g., 50% or more, such as 50%, 60%, or 70%). In an example, the fluid is a composition including (exactly or about) 60% distilled water and (exactly or about) 40% lubricants and/or additional compounds. Distilled water expands up to 3,600 times in volume when transitioning from liquid form to gas form (e.g., vaporization) in a controlled environment. In the present disclosure, the vaporization of the fluid including distilled water produces a rapid expansion, thereby generating a rapid increase in pressure that generates a force against a surface that drives a mechanical output, such as a piston of an engine that drives a crankshaft. The fluid can be thermally stable, in that the fluid maintains a stable density through various temperatures and dilutions. In some instances, the expansion of the distilled water component of the fluid upon vaporization provides an efficient transfer of energy and pressure in an expansion engine, such as a piston-based engine, and can be condensed back to liquid phase from vapor phase and recirculated for reuse in an engine cycle of an engine system. The properties of the fluid provide efficient, sustainable, and repeatable performance for multiple expansion and condensation cycles of an engine.

In an example engine system of the present disclosure, mechanical energy is produced by fluid expansion (e.g., vaporization) of the fluid from liquid phase to gas phase and/or vapor phase to drive movement of one or more pistons in an engine. The rapid expansion of the fluid allows for direct energy conversion from heat to mechanical work, which can reduce intermediate losses such as friction or thermal runaway as compared to internal combustion engines. The fluid is pressurized and cycled through a closed loop fluid cycle such that, after fluid expansion, the fluid returns to its liquid form, such as through condensation at a condenser. Certain fluids greatly expand during transformation from liquid to gas phases, such as expansion up to 3,600 times in volume. Example engine systems described in this disclosure capitalize on this fluid expansion and apply it to drive a piston(s) of an engine and generate mechanical output (e.g., engine shaft rotation and torque), while recirculating and reusing the fluid through multiple thermodynamic cycles of fluid expansion and condensation with minimal to no energy loss of the fluid. In some implementations, the transformation of the fluid from liquid to gas generates efficient mechanical energy without generating harmful emissions and pollutants. For example, the example engine system excludes the use of fossil fuels so there are no generated polluting byproducts, thus reducing the carbon footprint of the example engine system and allow it to be used in areas with strict environmental regulations. In some instances, the example engine system is considered to be a closed-cycle electric engine, for example, because it relies on electric power to drive several components of the engine system. Since there is no combustion or ignition, the example engine system produces significantly less noise for a quieter operation, which can be beneficial in urban environments or indoor applications or other systems where low acoustic impact is beneficial (e.g., electric vehicles, drones, boats, a combination of these, or other applications). Further, the example engine system requires less maintenance (compared to internal combustion engines) because the absence of combustion and the use of a clean, recirculated fluid reduces buildup, carbonization, and wear on valves and pistons. In some instances, this application can remove or reduce traditional maintenance operations, and can also shorten maintenance intervals, though regular maintenance intervals for vehicles are still recommended. For example, the operational energy savings of the present engine system is 80% or greater compared to an internal combustion engine system, and maintenance intervals can be extended by 300%, for example, due to inherent internal lubrication of the closed loop fluid cycle of the engine system. Further, since the fluid is heated by electrical induction, the example engine system can be powered by solar, wind, battery storage, or other electricity-generating devices without requiring fossil fuels, instead or in addition to an alternator incorporated into the engine system.

In some implementations, an example engine system relies on electronic activation of induction coils to prompt fluid expansion. Use of electronic activation can provide an effectively instant response to power demand, allowing for adjustment in the amount of fluid used in expansion (e.g., vaporization) to be controlled in real time. Also, operating the example engine system in a controlled temperature range (e.g., between 46 degrees Celsius (C) and 110 degrees C), the example engine system is subjected to less thermal stress, thus extending the life of the structural components of the engine system. Further, the scale of the example engine system can vary based at least partially on application, for example, such as smaller applications (e.g., portable generators or micromobility) to larger applications like industrial or heavy-duty transportation systems (e.g., by adapting cylinder size, injector number, and/or thermal capacity). In some instances, the example engine system incorporates heat or ambient recovery modules that can improve the efficiency of the closed loop fluid cycle without compromising thermal safety. Further, the example engine system can be integrated with auxiliary battery and/or regenerative systems such that the engine can maintain stable operation even with load or power supply fluctuations, providing energy security.

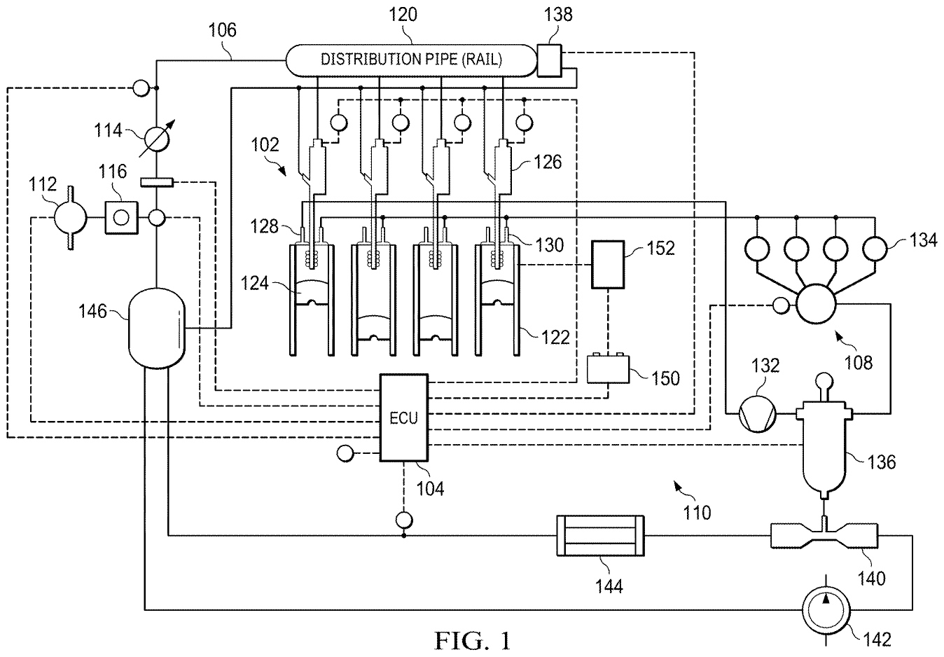

FIG. 1 is a schematic view of an example engine system 100 including an engine 102, an engine control system 104 (or engine control unit (ECU)), an exhaust system 108, and a recirculation system 110. The example engine system 100 includes a closed loop fluid cycle 106 through the example engine system 100, for example, from the engine 102 to the exhaust system 108 and further to the recirculation system 110, to circulate a fluid through the example engine system 100. The fluid expands to provide the mechanical output to the engine 102, then condenses back to liquid phase for recirculation and reuse in the engine 102 in a further expansion cycle. In some instances, expansion of the fluid in the closed loop fluid cycle 106 from (substantially or completely) liquid phase to (substantially or completely) gaseous phase in the engine 102 drives movement of pistons of the engine 102 and provides a mechanical energy output of the engine 102. The fluid then flows to the exhaust system 108, where all or a portion of the fluid is directed to the recirculation system 110. In some instances, a portion of the fluid in gaseous phase is redirected back to the engine 102 instead of to the recirculation system 110. These operations are described in greater detail later.

The fluid is recirculated through the closed loop fluid cycle 106 without being entirely consumed (e.g., at the engine 102) nor exhausted to ambient. The fluid is reused (e.g., for multiple cycles or indefinitely) without needing to be replenished, other than replenishing any fluid loss due to seal degradation or failures, leakage, frictional losses, degradation of the lubricant in the fluid through continued used, and/or other minor losses. There is zero or negligible designed loss of the fluid through its vaporization process. For example, the fluid changes phase between liquid phase and gas phase throughout its cycle through the closed loop fluid cycle 106, but the phase change does not alter the chemical composition of the fluid (other than its phase change) in the way that combustible hydrocarbon-based fuels are altered in an internal combustion engine that exhausts combusted hydrocarbon fuels to ambient. The example engine system 100 operates under the thermodynamic principle of thermal expansion, similar to an internal combustion engine, but the fluid, operating as fuel to the engine 102, operates within the closed loop flow of the fluid and without producing harmful emissions associated with hydrocarbon-based combustion engines. In some implementations, the example engine system 100 operates in a similar manner as an internal combustion engine in that thermal expansion in a cylinder produces a force to drive a piston, except that the thermal expansion in the example engine system 100 is produced from the expansion of the fluid from liquid phase to gas phase that flows through the system 100 in a closed loop, instead of through thermal expansion by ignition and combustion of fuel that is then exhausted (e.g. to the atmosphere). In some instances, the example engine system 100 can produce the same or similar power output from the engine 102 as an internal combustion engine, without producing pollutants or other harmful emissions via combustion of hydrocarbon-based fuel. In some instances, about 4 liters of the fluid is incorporated into the fluid circuit 106 for every 1 liter (1,000 cubic centimeters, or cc) of engine displacement. For example, in a 5,000 cc engine, the fluid circuit includes 20 liters (or more) of the fluid. Since the fluid is recirculated and reused (instead of consumed) during operation of the engine system, the costs for operating the example engine system 100 includes just the cost for an initial volume of the fluid to be added to the example fluid circuit 106.

The composition of the fluid circulated in the closed loop fluid circuit 106 includes a first component of distilled water and a second component of lubricating material and additional compounds. In an example composition, the fluid includes about 60% distilled water and about 40% of the second component. However, the percentage of these components can vary. In some instances, the distilled water component can be between about 55% and about 70%, and the second component can be between about 30% and about 45%. In an example composition, the fluid includes about 60% distilled water, and has a fluid density of 0.9975 grams per cubic centimeter (g/cm 3) (at 20 degrees C). The composition of the fluid allows for adjustments within certain allowable ranges for each functional group (described in more detail later) to adapt to specific operating conditions, such as altitude, ambient temperature, operating pressure, or maintenance requirements. Upon transitioning from liquid phase (distilled liquid water) to gas phase (distilled water vapor), distilled water greatly expands (e.g., up to 3600 times in a void, and up to 1800 times in a 1 bar pressure environment) in volume. The present disclosure capitalizes on this rapid increase in pressure and volume as a driving force, for example, against a piston to drive a crankshaft and produce a mechanical output. The second component of the fluid composition provides lubrication and thermal stability to the fluid through several thermodynamic cycles as the fluid is recirculated through the closed loop fluid circuit 106 of the example engine system 100. For example, the fluid, with its distilled water component and second component, provides a solution with a low viscosity (e.g., having a density of 0.9975 grams per cubic centimeter at 20 degrees Celsius), high vaporization capacity (e.g., a vaporization rate fluctuating between 1800 times at one bar and 3600 times under vacuum, high lubrication properties (e.g., the fluid having a viscosity index of 95 or greater, such as between 95 and 102), and ability to withstand the high temperatures and pressures of an engine. In some examples, the second component atomizes and deposits on cylinder walls of the engine 102 to provide lubrication that reduces friction and wear of components of the engine 102. In some implementations, the second component includes alcohol (e.g., methanol, propanol, sec-butanol, isobutanol, phenylethyl alcohol, p-guaiacol, and/or other alcohols), hydrocarbons, fatty acids (e.g., palmitic acid, oleic acid, and/or stearic acid), and various other organic compounds like sec-butyl acetate, glycerol dichlorohydrin, butyraldehyde dibutyl acetate, butyl octyl phthalate, dioctyl adipate, and/or dioctyl phthalate. The alcohol component improves fluid atomization and heat transfer, and help maintain a homogenous distribution of the fluid. The fatty acid component act as thermally stable lubricants, and can reduce friction and wear on the components along the closed loop fluid cycle 106. The hydrocarbon component help provide thermal stability to the fluid, improving viscosity and high temperature fluid durability. The other various organic compounds can help contribute to lubrication, anti-corrosion, and pH control of the fluid, and in some examples, increase surface adhesion of the lubricant to metal components of the example engine system 100. For example, glycerol dichlorohydrin can act as a wetting or emulsifying agent, and one or more of sec-butyl acetate, dioctyl phthalate, or dioctyl adipate can act as a plasticizer, viscosity modifier, and/or thermal stabilizer. In some example compositions of the fluid, the fluid includes distilled water and fatty acids and excludes alcohols, hydrocarbons, and/or other various organic compounds. In certain examples, the fluid includes distilled water, fatty acids, and one or more of alcohols, hydrocarbons, or other organic compounds.

In some implementations, the fluid has a density of about 0.9978 grams per milliliter (g/ml) (or g/cm³), and maintains a substantially constant density among various dilution conditions. For example, the density of the fluid provides fluidity, rapid vaporization, and compatibility of the fluid with high-pressure injectors (e.g., injectors 126 at 200 bar, described later). In certain instances, the density of the fluid can vary, such as between 0.9975 and 0.9978 g/cm³ (e.g., at 25 degrees C). In some instances, the composition of the fluid, by weight, includes 60% distilled water, 2.7% alcohols (including methanol, propanol, sec-butanol, isobutanol, phenylethyl alcohol, and p-Guayacol), 3.0% hydrocarbons (e.g., mineral oil hydrocarbons, including dean, dodecane, tetradecane, hexadecane, various C18 isomers, Eicosane, C20 isomers, heneicosane, C21 isomers, docosane, C22 isomers, tricosane, C23 isomers, tetracosane, and C24 isomers), 5.4% fatty acids (including palmitic acid, oleic acid, oleic acid isomer, and stearic acid), and about 2.05% organic compounds (including sec-butyl acetate, glycerol dichlorohydrin, butyraldehyde dibutyl acetate, butyl octyl phthalate, dioctyl adipate, and dioctyl phthalate). In certain examples, the composition of the fluid includes at or about 60% water, at or about 8.21% alcohols, at or about 9.12% hydrocarbons, at or about 16.42% fatty acids, and at or about 6.23% miscellaneous organic compounds. Additional and alternative features of the fluid are described elsewhere in this disclosure.

The engine control system 104 controls operation of the components of the example engine system 100 and regulates the flow of the fluid through the closed loop fluid cycle 106. The example engine system 100 includes a number of components along the closed loop fluid cycle 106, some or all of which are communicably connected to the engine control system 104, such as for monitoring, controlling, regulating, or otherwise affecting flow of the fluid through the fluid cycle 106, operation of the engine 102, exhaust system 108, and/or recirculation system 110, and/or overall operation of the example engine system 100.

The example engine system 100 includes an electric motor 112 and a fluid pump 114 powered by the electric motor 112 (and/or by a battery 150, described later). The pump 114 is fluidly connected to the closed loop fluid cycle 106 to drive flow of the fluid along a fluid pathway of the fluid cycle 106. The fluid pump 114 pressurizes the fluid in the fluid pathway of the fluid cycle 106 upstream of the engine 102. The fluid pump 114 is positioned along the fluid pathway upstream of the engine 102, for example, such that the fluid pump 114 provides a constant flow of the fluid to the engine 102 and/or maintains a pressure (e.g., at or above a minimum pressure threshold) of the fluid in the portion of the fluid cycle 106 leading to the engine 102. In some implementations, the electric motor 112 directly drives components of the example engine system 100, such as the fluid pump 114, allowing precise and continuous control of the flow of the fluid through the closed loop fluid cycle 106.

In some implementations, the example system 100 includes a gearbox 116 (or torque multiplier) mechanically disposed between the electric motor 112 and the fluid pump 114 to provide a controlled torque to the fluid pump 114. For example, the gearbox 116 can multiply and/or vary the speed and/or torque provided by a shaft of the electric motor 112 according to desired intake conditions of the fluid pump 114. In certain implementations, the gearbox 116 is incorporated into the fluid pump 114 instead of disposed mechanically between the electric motor 112 and the fluid pump 114. The gearbox 116 acts as a mechanical coupling between the electric motor 112 and the fluid pump 114, for example, to modulate the torque and rotational speed that the electric motor 112 delivers to the fluid pump 114 based on the system requirements and needs of the example system 100. For example, the gearbox 116 allows for the fluid pump 114 to receive a higher output torque at lower rotational speed when high fluid pressure is desired in the fluid cycle 106, and can adjust the rotational speed of the fluid pump 114 to precisely control the flow of fluid through the fluid cycle 106. The gearbox 116 can also act to match mechanical impedance between the electric motor 112 and the fluid pump 114, for example, by compensating for differences between the characteristics of the electric motor 112 (e.g., high speed, low torque) and the fluid pump 114 (varying speed and torque requirements).

The engine 102 of the example engine system 100 is depicted as a reciprocating piston engine. In certain instances, the engine 102 may be another type of engine, such as a Wankel rotary engine, or other expansion chamber style engine. In the example engine system 100 of FIG. 1, the engine 102 includes a distribution conduit 120 and an engine block that includes one or more piston cylinders 122 (four shown). A piston 124 (four shown) is disposed in a respective one of the piston cylinders 122, and injectors 126 (four shown) are disposed partially within each of the piston cylinders 122 to direct a controlled amount of the fluid into the chambers defined by the cylinders 122 and their respective pistons 124. The pistons 124 are fluid-sealed to the wall of the cylinder 122, such that the cylinder 122 and a surface of the piston 124 define a fluid sealed chamber for the fluid to reside in. Each piston 124 can include one or more sealing elements, such as O-rings, gaskets, or other sealing elements to seal against the inner surface of the cylinder 122.

The fluid distribution conduit 120 supplies and directs the pressurized fluid to the injectors 126 for injection of the fluid into the respective cylinders 122. The distribution conduit 120 maintains a pressure of the fluid to the injectors 126 at or above a minimum pressure threshold, such as 2,000 bar. A minimum pressure threshold of 2,000 bar can provide optimal performance of the fluid in the cylinders 122; however this minimum pressure threshold can vary, such as between 500 bar and 2500 bar. For example, a pressure threshold of 500 bar can be used for start-up operation or low thermal load conditions, and can promote or ensure minimal fluid atomization. In some examples, a minimum pressure threshold between 800 bar and 2,000 bar can define an efficient operating range for the fluid, and a minimum pressure threshold between 1,800 and 2,000 bar can define an optimum performance pressure, such that thermal-mechanical conversion is highest and vaporization of the fluid can be instantaneous, generating efficient mechanical output of the pistons. In certain instances, the pressure can be greater than 2,000 bar, such as between 2,200 bar and 2,500 bar. The engine control system 104 (e.g., electronic control system) can automatically regulate the pressure depending at least in part on the load, temperature, and/or energy demand of the example engine system 100. The engine control system 104 can incorporate a real-time pressure monitoring system at the engine 102 to monitor the pressure of the fluid flowing into the engine 102. The fluid pump 114 and injectors 126 are constructed from materials with high resistance to fatigue and corrosion to withstand the pressures and temperatures of operation. In some implementations, the distribution conduit 120 includes a pressurized chamber, such as a reservoir or fluid-sealed chamber, with an inlet to receive the fluid flowing from the pump 114 and one or more outlets (four shown) to direct pressurized fluid to the injectors 126. The distribution conduit 120 can include an arrangement of intake pathways, or ducts, that direct fluid from a chamber of the distribution conduit 120 to the injector(s) 126 of the engine 102.

The injectors 126 are fluidly connected to the distribution conduit 120 (e.g., via intake pathways) to receive a portion of the fluid and control injection of the fluid into the cylinder(s) 122. In operation, the injectors 126 are positioned within a head portion of a respective cylinder 122 and enable injection of the fluid into the cylinder 122 prior to expansion (e.g., vaporization) of the fluid in the chamber of the cylinder 122 to generate a force against the piston 124. In some implementations, each cylinder 122 includes one or more intake valves 128 and one or more exhaust valves 130. In certain instances, the intake valve 128 is excluded. In some examples, the intake valve 128 receives a portion of the fluid to flow into the chamber of the cylinder 122, and the exhaust valve 130 exhausts fluid from the cylinder 122 toward the exhaust system 108, described in more detail later.

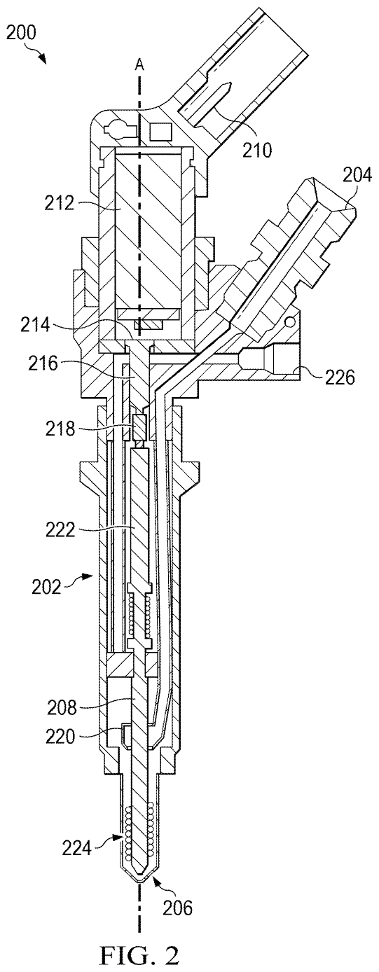

FIG. 2 is a cross-sectional front view of an example injector 200 that can be used as an injector 126 in the example engine system 100 of FIG. 1. The example injector 200 is the same as the injector 126 of FIG. 1, and includes an injector housing 202 having an elongate shape oriented along a longitudinal axis A-A, a fluid inlet 204 formed in the injector housing 202, a fluid outlet 206 formed in the injector housing 202 (e.g., such as outlet holes in the housing 202) at a longitudinal end of the injector housing 202, and a movable needle 208 movable between an open position (to allow fluid flow through the fluid outlet 206 and into the chamber of the cylinder 122) and a closed position (to seal flow of fluid through the fluid outlet 206). The needle 208 of the example injector 200 is oriented along the axis A-A and adapted for movement along the axis A-A; however, the location and movement of the needle 208 can vary from the orientation shown in FIG. 2. The example injector 200 also includes electrical components within its housing 202, for example, that control the flow of fluid through the injector 200, such as by controlling the position of the needle 208 between its open position and closed position. In the example injector 200 of FIG. 2, the injector 200 includes an electrical connector 210 to receive a power supply, such as from a battery or the electric motor 112. The example injector 200 also includes a piezoelectric element 212, an amplifier 214, a control piston 216, and a shut-off valve 218. The injector housing 202 also defines a needle chamber 220 fluidly connected to the fluid outlet 206. The needle 208 resides at least partially within the needle chamber 220, and acts to engage and seal the fluid outlet 206 in the closed position and is spaced apart from the fluid outlet 206 in the open position. A needle control piston 222 controls the movement of the needle 208 between the open position and the closed position. The piezoelectric element 212, upon receiving an electrical signal, can change shape (e.g., expansion or contraction) very quickly and precisely to transform the electrical signal into mechanical motion. The motion of the piezoelectric element 212 initiates the movement of the control piston 216. The amplifier 214 multiplies the movement of the piezoelectric element 212. Since the actual displacement of the piezoelectric element is small (e.g., on the order of microns), the mechanical amplifier 214 translates this expansion into a larger displacement, allowing the control piston 216 to be effectively controlled. The control piston 216 provides the force transmission and flow control of the fluid through the example injector 200. The control piston 216 moves longitudinally in response to the amplified movement of the piezoelectric element 212 and acts directly on the injector needle 208, causing it to rise (open position) or settle (closed position). The shut-off valve 218 provides safety and precision, for example, by regulating or blocking fluid flow to the needle chamber 220 or needle 208, and can act as a hydraulic backup to ensure the needle 208 closes quickly when needed.

The example injector 200 also includes an activator 224 operative to initiate the phase change of the fluid in the chamber of the cylinder 122 and/or the fluid in the needle chamber 220. In the example injector 200 of FIG. 2, the activator 224 includes an induction coil oriented around the needle 208. The induction coil (or multiple induction coils) functions to heat the fluid to a phase transition temperature (e.g., 70 degrees Celsius or other temperature). The activator 224 selectively heats the fluid at an appropriate time to raise the temperature of the fluid to (at least) its transition temperature before or during the injection of the fluid into the cylinder 122. The activator 224 can rapidly heat the fluid to induce the phase change instantaneously. In some implementations, this instantaneous change is defined as a minimal amount of time suitable for the operating time scales of an engine, typically on the order of milliseconds (ms) or even sub-milliseconds (Ts). For example, the activator 224 (e.g., induction coil(s)) can heat the fluid by means of eddy currents and/or hysteresis losses in 0.1 ms to 5 ms to raise the temperature of the fluid from near ambient (e.g., about 25 degrees C) to its phase transition temperature (e.g., about 70 degrees C) or higher. This phase change of the fluid causes rapid expansion of the fluid, which rapidly increases the pressure of the fluid within the cylinder 122 and generates a force in the cylinder 122 that acts against a surface of the piston 124 to drive movement of the piston 124. In some examples, the power of each induction coil is between 50 Watts (W) and 200 W in microinjection, and the operating frequency can be from 100 kilohertz (kHz) to 1 megahertz (MHz).

In the example injector 200 of FIG. 2, the induction coil 224 is electrically powered, and operates intermittently such that it is activated and deactivated in controlled cycles (e.g., controlled by the engine control system 104) such that activation and deactivation are triggered at the exact moment and duration of the activation of the induction coil 224, for example, according to engine power demand and operating conditions of the engine 102. When the induction coil 224 is activated, an induced magnetic field generates heat in the metal of the needle 208, and the heat is transferred to the fluid as it passes through the injector 200 and/or across the activator 224, raising the temperature of the fluid to the transition temperature (e.g., vaporization temperature of the fluid). The activator 224 controls heating of the fluid to precise temperature(s) to ensure the fluid is substantially or entirely transitioned to its gaseous phase (e.g., substantially or fully vaporized) upon entering the chamber of the cylinder 122. In operation, the induction coils need not be activated continuously. Their operating range is between 75 W and 100 W, and operate at higher frequency intervals during startup, and are activated when needed for fluid phase change. In some instances the induction coils retain residual heat between activation cycles. The induction coils are adapted to reach up to between 600 C and 800 C, though a lower temperature than this maximum is sufficient for fluid phase activation. The induction coils activate intermittently to maintain a temperature sufficient to initiate the vaporization of the fluid.

In some implementations, the example injector 200 includes a second fluid inlet 226 incorporated into the housing 202, for example, to direct the fluid and/or supplemental fluid through the injector 200 toward the chamber 220. In certain instances, the second fluid inlet 226 of the example injector 200 can operate as a supplemental fluid path to or a replacement fluid path from the fluid inlet 204 of the example injector 200, for example, for fluid being supplied to the injector 200.

Referring to both the example engine system 100 of FIG. 1 and the example injector 200 of FIG. 2, the engine control unit 104 operates the engine 102 and injector(s) 126, 200 to produce controlled expansion of the fluid in the engine 102 to generate a mechanical output. In operation, the pistons 124 within each cylinder 122 move between a top-dead-center (TDC) position and a bottom-dead-center (BDC) position. The engine 102 can include a crankshaft (not shown) that is connected to each piston 124 such that the pistons 124 move between the TDC and BDC positions within each cylinder 122 and rotate the crankshaft. The TDC position is the position the piston 124 with a minimum volume of the chamber of the cylinder 122 (i.e., the piston's 124 closest approach to the injector 126, 200 and top of the chamber), and the BDC position is the position of the piston 124 with a maximum volume of the chamber of the cylinder 122 (i.e., the piston's 124 farthest retreat from the injector 126, 200 and top of the chamber). In some implementations, a vacuum pump 132 resides in the closed loop fluid cycle 106 and fluidly connected to the exhaust system 108 to quickly extract the expanded gases from the expansion chamber. For example, the exhaust valve 130 controls the flow of the fluid from the chamber of the cylinder 122 to the exhaust system 108 via opening the exhaust valve 130, and the vacuum pump 132 acts to pull the gases from the chamber of the cylinder 122 through the exhaust valve 130 and toward the exhaust system 108. The intake valve 128, exhaust valve 130, or both, can be controlled with a valve actuation assembly for each cylinder 122, which can be electronically, mechanically, hydraulically, or pneumatically controlled, or controlled via a camshaft (not shown).

In an example operation, movement of the piston 124 between the TDC and BDC positions within each cylinder 122 defines an intake stroke, a compression stroke, an expansion stroke (e.g., a power stroke), and an exhaust stroke. The intake stroke is the movement of the piston 124 away from the injector 126, and in some instances, where the intake valve 128 is open to allow the fluid to enter the chamber of the cylinder 122. The compression stroke is the movement of the piston 124 towards the injector 126 with the fluid in the chamber of the cylinder 122 and both the intake value 128 and exhaust valve 130 are closed, thereby enabling the movement of the piston 124 to compress the fluid in the chamber of the cylinder 122. The expansion stroke is the movement of the piston 124 away from the injector 126 that occurs during and/or after the vaporization, or phase change from liquid to gas, of the fluid through the injector 126. The fluid rapidly expands during vaporization to increase the pressure in the chamber of the cylinder 122, which applies a force on the piston 124 to move the piston 124 away from the injector 126, such as from TDC to BDC. The downward movement of the piston 124 generates mechanical work and rotates the crankshaft. The exhaust stroke is the movement of the piston 124 towards the injector 126 (e.g., from BDC to TDC) after the expansion stroke and with the exhaust valve 130 open to allow the piston 124 to expel the fluid in the cylinder 122 to the exhaust system 108. In an example operation, the vaporization rate (e.g., expansion) of the fluid can vary between 1800 times at one bar of pressure and 3600 times when under vacuum conditions, such as when the piston 124 in the cylinder 122 moves toward bottom dead center (BDC) and the valves to the cylinder 122 are closed.

In some implementations, the engine 102 includes one or more glow plugs disposed in the chamber(s) of the cylinder(s) 122. The glow plugs can heat the fluid in the cylinder chambers, such as during startup of the engine 102, to obtain an adequate temperature for the correct expansion of the fluid in the chambers. In some implementations, the glow plugs can thermally preload the cylinder chamber during engine startup to that fluid more easily reaches its phase transition temperature from the first cycle. In some instances, glow plugs are beneficial in in cold environments, such as when the engine fluid and metal surface of the engine 102 are at low temperatures. During normal operation of the example engine system 100, glow plugs can be used to complement the heating function of the activator 224, and/or act as auxiliary or backup heaters, remaining active cyclically or intermittently. In some examples, the glow plugs can help improve inefficient heating by the activator 224 and/or increase fluid heating time for a more efficient and/or more complete phase transition of the fluid, such as under high load or fast transient engine conditions.

After the fluid is expanded in the engine 102, the fluid is directed to the exhaust system 108. The exhaust system 108 includes an exhaust manifold 134 in fluid communication with the cylinders 122. The exhaust manifold 134 receives the fluid from the cylinders 122 via the exhaust valves 130, and combines the separate fluid flows into a single flow directed toward the recirculation system 110. The exhaust manifold 134 includes an arrangement of fluid conduits, or ducts, designed for the fluid in a completely or mostly gaseous state. In some examples, the exhaust manifold 134 is made of materials that can withstand high temperatures of the expanded fluid while maintaining structural integrity, mechanical strength, and functional performance during continuous and repeated exposure to elevated temperatures (e.g., between 300 C and 700 C). For example, the exhaust manifold 134 does not deform plastically or crack due to thermal fatigue, does not rust or corrode excessively upon prolonged contact with hot gases, does not lose its thermal conductivity or sealing capacity, and does not release volatile compounds or chemically degrade in the presence of the expanded fluid. The exhaust manifold 134 can include stainless steel, nickel alloys, nodular cast iron, ceramics or ceramic composites, titanium, a combination of these materials, or other materials. The exhaust manifold 134 is sized to efficiently direct the fluid flow from the engine toward the recirculation system 110, though it is not too large so as to create a backpressure at the exhaust valves 130 of the engine 102.

The recirculation system 110 receives fluid from the exhaust system 108 and prepares it for reuse, recirculation, and/or storage. The recirculation system 110 of the example engine system 100 includes a coalescing filter 136, the vacuum pump 132, a venturi system 140, a second fluid pump 142, a condenser 144, and a fluid reservoir 146. The recirculation system 110 is positioned along the closed loop fluid cycle 106 such that the fluid from the exhaust system 108 is received by the recirculation system 110 and directed along one or more fluid pathways in preparation for its reuse in a future expansion cycle in the engine 102. For example, the recirculation system 110 receives the fluid from the exhaust manifold 134, condenses the fluid into liquid form, and prepares the liquid form of the fluid for recirculation to the fluid pump 114. In some implementations, recirculation system 110 can include a compressor (e.g., in place of the vacuum pump 132) to drive fluid flow through the recirculation system 110.

In an example operation, the example engine system 100 generates mechanical power from the controlled expansion of the fluid in the cylinders 122 of the engine 102. This energy is transferred, for example, to an output shaft or an electric generator to power external loads or recharge a system battery. In parallel, the example engine system 100 includes components that consume electrical power, including one or more of the electric motor 112, the activator 224 (e.g., induction coils 224 and/or glow plugs), the engine control system 104 and its connected sensors and components, the condenser 144, and the second fluid pump 142 of the recirculation system 110. The energy balance of the example engine system 100 is the energy generated by the engine 102 relative to the energy consumed by the components that consume electrical power. The design of the example engine system optimizes this energy balance by electronically controlled injection and heating cycles to minimize induction coil activation time, efficient fluid recirculation through heat recovery in the exhaust system 108 and recirculation system 110, and in some instances, partial energy recovery to power internal electrical systems or recharge the battery 150. The example engine system 100 is designed to maximize energy efficiency by harnessing the phase change of the fluid as the primary source of mechanical energy. The engine 102 generates useful mechanical power by expanding the vaporized fluid in the cylinders 122, driving the pistons and transferring motion to the crankshaft. Some of this energy can be used to recharge the battery 150 and power the electric motor 112, which in turn drive essential system components such as the main fluid pump 114, the cooling system condenser 144, the fuel injection pump, electronic valves, piezoelectric injectors, and induction coils 224. Although these subsystems consume electrical energy, the design of the example engine system 100 ensures that the net energy consumption is lower than the mechanical energy generated by the engine 102, guaranteeing a positive energy balance.

The example engine system 100 is designed to maximize energy efficiency through controlled expansion of the fluid, which undergoes phase changes within the cylinders 122 and generates significant pressure to drive the pistons. This useful mechanical energy is transmitted to the crankshaft and can achieve, in some implementations, a conversion efficiency of up to 65-70% from the fluid's thermal energy to the output mechanical energy. In some instances, part of this energy is diverted to power the engine's electrical system, for example, via the battery 150 and/or the electric motor 112, and power the fluid pumps (estimated consumption 200-500 W), the recirculation system compressor (300-800 W), the injector induction coils (5-20 W per injector, cyclic activation), and the engine control system 104. The battery 150 acts as an auxiliary power source during start-up or under special conditions, but during normal operation the system 100 can remain energetically autonomous. Overall, the total estimated power consumption during stable, steady-state operation is around 1 to 2 kilowatt (kW), compared to mechanical generation that can exceed 10 kW in compact engines, ensuring a positive energy balance and efficient operation of the closed-loop system. Furthermore, in certain implementations, the example engine system 100 can incorporate energy recovery mechanisms, such as waste heat recovery from the exhaust system 108 or energy regeneration during passive phases of the cycle (e.g., compression or exhaust), to recharge the battery 150 or reduce the load on the electrical system. This can provide improvement in overall efficiency of the example engine system 100 and extend the operating autonomy of the example engine system 100. In some implementations, the example engine system can operate autonomously for extended cycles, with minimal need for external recharging, making the example engine system 100 a closed, energy-efficient system.

The coalescing filter 136 acts as a gas-liquid separator for the fluid from the exhaust manifold 134, and separates any liquid component from the gas component of the fluid. The coalescing filter 136 directs the liquid component further along the recirculation system 110, such as to the venturi system 140. In some implementations, the coalescing filter 136 can also direct the separated gas component of the fluid back to the engine 102, such as to the intake valves 128 of the engine 102, for injection into the chamber of the cylinders 122 at the compression stage. The vacuum pump 132, fluidly connected to the gas outlet of the coalescing filter 136, can aid in pressurizing and flowing the gas component of the fluid from the coalescing filter 136 to the engine 102. In certain instances, the coalescing filter 136 and vacuum pump 132 act as a vacuum pump to extract the expanded fluid residues from the exhaust system 108 and directing the fluid either back to the engine 102 or further along the fluid recirculation system 110. In some implementations, the vacuum pump 132 includes a turbo component, such as a turbo compressor. In certain implementations, the vacuum pump 132 includes a compressor.

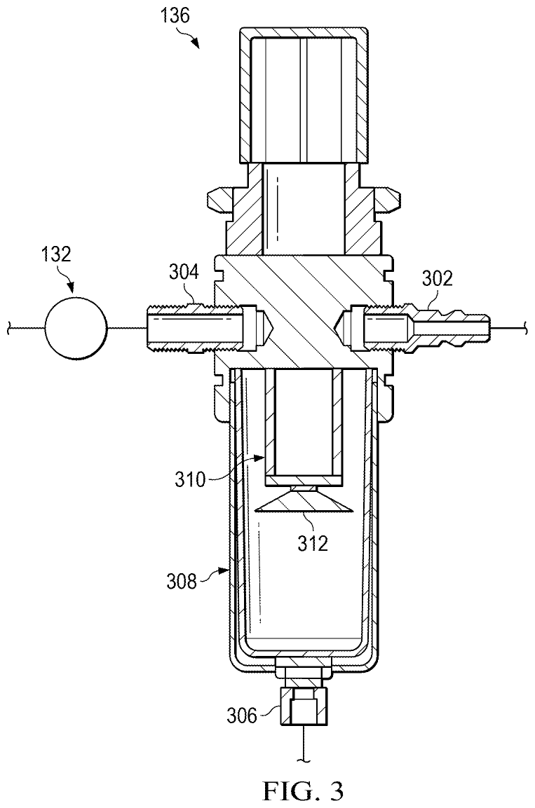

FIG. 3 is a schematic, partial cross-sectional front view of the example coalescing filter 136 and vacuum pump 132 of the recirculation system 110 of the example engine system 100 of FIG. 1. The coalescing filter includes an inlet 302 for receiving the fluid from the exhaust system 108, a gas outlet 304 for flowing the separated gas to the vacuum pump 132, and a liquid outlet 306 for flowing the separated liquid further along the recirculation system 110. The example coalescing filter 136 includes a housing 308 and a separator 310 disposed within the housing 308 to separate the gas component from the liquid component of the incoming fluid from the inlet 302. The separator 310 includes a coalescing element 312, which directs the liquid component toward the liquid outlet 306 and the gaseous component to the gas outlet 304. In some examples, the coalescing element 312 includes a fine mesh or fibrous material that the fluid passes through. The coalescing element 312 agglomerates the liquid droplets from the fluid and allows the droplets to drip toward the liquid outlet 306, whereas the gas component flows upward to the gas outlet 304.

Referring again to the recirculation system 110 of the example engine system 100 of FIG. 1, the venturi system 140, second fluid pump 142, condenser 144, and fluid reservoir 146 form a mechanical condensation system and fluid circuit that receives fluid from the coalescing filter 136 and cools and condenses the fluid to a liquid phase. This mechanical condensation system can store the fluid and/or circulate the fluid back to the fluid pump 114 for reuse in the engine 102. The venturi system 140 receives the fluid from the coalescing filter 136 and combines that fluid with existing fluid in the fluid circuit of the mechanical condensation system. The second fluid pump 142 drives flow of the fluid within the fluid circuit, and the condenser 144 condenses the fluid. The fluid reservoir 146 acts to store the condensed fluid from the condenser, and as needed, circulate the condensed fluid to the fluid pump 114 for reuse in the engine 102 or recirculate the fluid to the second fluid pump 142, for example, for recirculation through the fluid circuit of the mechanical condensation system.

The condenser 144 can include one or more heat exchangers made from materials with a high thermal conductivity (e.g., copper, aluminum) to facilitate heat transfer from the fluid to the environment or a separate cooling system. The heat exchanger(s) can include a series of tubes and fins to enhance heat exchange surface area. The condenser 144 can be made from corrosion-resistant metal alloys, such as stainless steel. The heat exchanger(s) reduces the temperature of the fluid so that it is entirely condensed to liquid phase prior to flowing to the fluid reservoir 146.

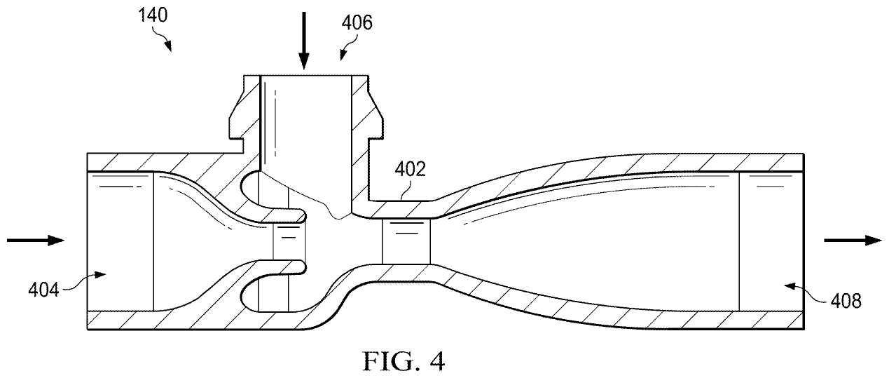

FIG. 4 is a schematic, partial cross-sectional front view of the example venturi system 140 of the recirculation system 110 of FIG. 1. The venturi system 140 includes a venturi portion within the fluid pathway with a reduced diameter section 402. A first inlet 404 receives a flow of fluid from the second fluid pump 142, and a second inlet 406 receives a flow of fluid from the coalescing filter 136. The two incoming fluid flows are combined within the venturi system 140 and flow to a fluid outlet 408, leading to the condenser 144. Combining the flow from the first inlet 404 and the second inlet 406 promotes efficient transfer of fluid to the condenser 144 and the subsequent reservoir 146. In some implementations, the pressurized flow of fluid from second fluid pump 142 to the first inlet 404 of the venturi system 140 creates a pressure differential at the second inlet 406, such that the flow of fluid from the coalescing filter 136 is biased into the second inlet 406 to combine with the flow of fluid from the first inlet 404 to the outlet 408. The venturi section creates a pressure drop through the venturi system 140 that optimizes condensation efficiency of the fluid. The venturi system 140 can be made from wear-resistant and corrosion-resistant materials, such as metal alloys like stainless steel.

During operation of the example engine system 100, such as during a compression stroke and power stroke, the engine control system 104 controls the supply of fluid to the engine 102, the flow of fluid from the engine and through the exhaust system 108, and through the recirculation system 110 between the exhaust system 108 and the engine 102 (in the direction of fluid flow). During each fluid expansion event and subsequent fluid expansion stages, the engine control system 104 controls vaporization timing and directs power to the activator 224 of the injector 126, 200 for controlled expansion of the fluid. The engine control system 104 receives feedback from a number of sensors and components of the example engine system 100, and can constantly adjust control based on the received feedback in real time. Multiple sensors can be placed throughout the example engine system 100 and in communication with the engine control system 104 to monitor sensor feedback and control engine operation. For example, the distribution conduit 120 includes a pressure sensor 138 to sense a pressure of the fluid in the distribution conduit 120. The engine control system 104 can monitor the data from the pressure sensor 138 and ensure the pressure in the distribution conduit 120 remains at or above the minimum threshold fluid pressure. Additional pressure sensors, temperature sensors, or other fluid characteristic sensors can be positioned along the fluid pathway of the closed loop fluid cycle 106 that the engine control system 104 can monitor. In some instances, the engine control system 104 can regulate operation of the injector 126, 200 based on the speed and/or load of the engine 102, and/or fluid pressure and/or temperature in the fluid cycle 106.

In some implementations, the example engine system 100 includes a battery 150 connected to one or more components of the example system 100 to provide power to the components. For example, the battery 150 can provide electric power to one or more of the fluid pump 114, activators 224, vacuum pump 132, second fluid pump 142, condenser 144, engine control system 104, various sensors, a combination of these, or other components within the example engine system 100. In some examples, the battery 150 can be charged using the mechanical output of the engine 102, such as by a generator including a rotor and stator configured to charge the battery upon rotation of the rotor relative to the stator. In certain examples, the battery supplies power to the control systems of the example engine system 100, such as sensors, electronic valves, and other control features. In some implementations, the battery 150 provides backup energy to components of the example engine system 100 in high demand situations, for example, when the electric motor 112 is not sufficient on its own to provide power to some or all of the electricity-consuming components of the example engine system 100.

The example engine system 100 generates a positive energy balance between engine output power (e.g., mechanical power output) and required input power (e.g., electrical loads and/or mechanical loads). In some implementations, operation of the example engine system 100 includes steady state electrical loads, mechanical parasitic loads, and transient loads. The steady state electrical loads can include electrical power used by the injectors 126 (e.g., the activator 224, such as the induction coils 224 of the injectors 126), ECU 104, fluid pump 114, the condenser 144 (e.g., condenser fans), various low-power components (e.g., sensors, telemetry, lights, and auxiliary instrumentation), a combination of these, and/or other components. The mechanical parasitic loads can include one or mechanical pumps (e.g., driven by a shaft or other accessory) of the engine system 100, the second fluid pump 142 (e.g., fluid recirculation pump of the recirculation system 110 and its associated control valves), mechanical coupling losses (e.g., mechanical losses between various gears and belts of the engine system 100), the vacuum pump 132 (e.g., the turbo component and/or vacuum pump, such as effects from the turbo component captured indirectly in a dynamometer torque differential under load), a combination of these, and/or other mechanical load components. The transient loads, such as temporary short-lived loads separate from steady state loads, can include devices used primarily and/or solely at engine system startup, such as the glow plugs (e.g., used during cold engine starts), and/or other transient or intermittent loads that are not active during steady state operation, such as occasional forced cooling cycles.

In some implementations, the example engine system 100 includes an alternator 152 mechanically connected to the engine output of the example engine system 100 and electrically connected to one or more or all of the electrical components of the example engine system 100. The alternator generates power based on the received mechanical output from the engine, and distributes the generated electrical power to electrical loads of the example engine system 100. The electrical output of the alternator can vary based on load requirements of the example engine system 100. In some examples, the alternator can generate between 1 kW and 1.54 kW, with a nominal voltage between 13.8 and 14.2 Volts (V) and a typical current ranging between 70 amps (A) and 110 A. In an example implementation where the engine system 100 is incorporated into a vehicle, the usable headroom of the alternator after incorporating base loads of the vehicle is between 800 W and 1,100 W, with a continuous rating of 70 A to 90 A at 14 V, equivalent to about 980 W to 1,260 W. However, the output characteristics of the alternator can vary based on the alternator specification, and an alternator with greater or lesser power output can instead be incorporated into the engine system 100.

The loads and power requirements from the components of the example engine system 100 can vary during operation. In some instances, the electric motor 112 consumes between 25 W and 45 W, the fluid pump 114 consumes between 72 W and 96 W, the multiple injectors 126 consume between 8.4 W and 12 W, the activator 224 (e.g., induction coils) consumes between 75 W and 100 W, the vacuum pump 132 (e.g., turbo compressor or vacuum pump) consumes between 48 W and 60 W, the ECU 104 consumes between 28 W and 36 W, various valve and sensor components consume up to 20 W (e.g., between 8 W and 14 W), and the condenser 144 consumes between 60 W and 72 W, where the battery 150 provides a 12 V, 75 AH, 630 A power source for certain components. The alternator can supply electrical power for some or all of these components during operation of the engine system 100 during steady state operation. In certain instances, the battery 150, the alternator, or both, provide power to any transient loads, as needed.

The example engine system 100 is a low energy consumption activation system, and is adapted to deliver a continuous output power that is significantly larger than its mechanical and electrical loads. The example engine system 100 can be adapted to output a range of mechanical power based on output demands of a vehicle that incorporates the engine system 100, and the components of the example engine system 100 can be adapted to consume a range of electrical and/or mechanical power during varied operation. In an example operation, the engine system 100 delivers a continuous mechanical power output of between 95 horsepower (HP) and 102 HP (i.e., equivalent to between 70.8 kW and 76.1 kW, where 1 HP equals 745.7 W), where the mechanical load is between 4 HP and 7.5 HP, and all electrical load is covered by the alternator. In some instances, the example engine system 100 consumes between 4% and 8% of the mechanical power output in order to operate the required loads of the example engine system 100.

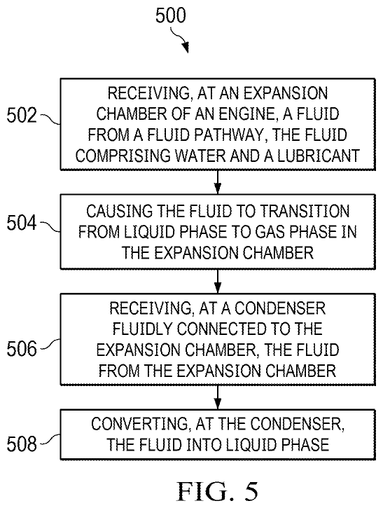

FIG. 5 is a flowchart describing an example method 500 for operating an engine, for example, performed by the example engine system 100 of FIG. 1. At 502, receiving, at an expansion chamber of an engine, a fluid from a fluid pathway is received at an expansion chamber of an engine. The fluid comprises distilled water in a concentration of 55% by weight or greater. At 504, the fluid transitions from liquid phase to gas phase in the expansion chamber. At 506, the fluid from the expansion chamber is received at a condenser fluidly connected to the expansion chamber. At 508, the fluid is converted into liquid phase at the condenser.

### Energy Fluids

Some embodiments provide an energy fluid, also referred to herein as “fluid.” The fluid can be used and/or implemented in any of the engines, systems, and/or methods described herein. For example, the fluid can be incorporated into the closed loop fluid cycle 106 of the example engine system 100 of FIG. 1. The fluid is a stabilized microemulsion that, when heated, vaporizes and expands, thereby generating pressure that generates a force against a surface that drives a mechanical output.

In some embodiments, the fluid comprises an expansion medium. In some embodiments, the expansion medium comprises water. In some embodiments, the expansion medium comprises propylene glycol. In some embodiments, the expansion medium comprises water. In some embodiments, the expansion medium comprises water and propylene glycol. In some embodiments, the expansion medium comprises one or more corrosion inhibitors. In some embodiments, the water is deionized water. In some embodiments, the water is distilled and deionized water. In some embodiments, the water is American Society for Testing and Materials (ASTM) Type I ultrapure water. In some embodiments, the fluid comprises water. In some embodiments, the fluid comprises about 30 wt. % to about 85 wt. % (e.g., about 55 wt. % to about 70 wt. %, about 55% wt. % to about 65 wt. %, about 50 wt. % to about 60 wt. %, about 60 wt. % to about 70 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, or about 60 wt. %) expansion medium. In some embodiments, the fluid comprises about 55 wt. % to about 70 wt. % expansion medium. In some embodiments, the fluid comprises about 60 wt. % expansion medium.

In some embodiments, the fluid comprises a volatility regulator and nucleation enhancer. In some embodiments, the volatility regulator and nucleation enhancer comprises an alcohol. In some embodiments, the alcohol is selected from the group consisting of: isopropyl alcohol, ethanol, n-propanol, and t-butanol. In some embodiments, the alcohol comprises isopropyl alcohol. In some embodiments, the alcohol is isopropyl alcohol. In some embodiments, the alcohol comprises isopropyl alcohol and ethanol. In some embodiments, the isopropyl alcohol and ethanol form an azeotrope. In some embodiments, the fluid comprises about 5 wt. % to about 27 wt. % (e.g., about 10 wt. % to about 22 wt. %, about 10 wt. % to about 14 wt. %, about 14 wt. % to about 20 wt. %, about 11 wt. % to about 17 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, or about 19 wt. %) volatility regulator and nucleation enhancer. In some embodiments, the fluid comprises about 10 wt. % to about 22 wt. % volatility regulator and nucleation enhancer. In some embodiments, the fluid comprises about 14 wt. % volatility regulator and nucleation enhancer.

In some embodiments, the fluid comprises a heat capacity enhancer and cavitation stabilizer. In some embodiments, the heat capacity enhancer and cavitation stabilizer comprises a glycol. In some embodiments, the glycol is selected from the group consisting of monoethylene glycol, propylene glycol, diethylene glycol, and triethylene glycol. In some embodiments, the glycol comprises monoethylene glycol. In some embodiments, the glycol is monoethylene glycol. In some embodiments, the fluid comprises about 2 wt. % to about 25 wt. % (e.g., about 4 wt. % to about 12 wt. %, about 4 wt. % to about 8 wt. %, about 6 wt. % to about 10 wt. %, about 8 wt. % to about 12 wt. %, about 4 wt. %, about 5 wt. %, about 6 wt. %, about 7 wt. %, about 8 wt. %, about 9 wt. %, about 10 wt. %, about 11 wt. %, or about 12 wt. %) heat capacity enhancer and cavitation stabilizer. In some embodiments, the fluid comprises about 4 wt. % to about 12 wt. % heat capacity enhancer and cavitation stabilizer. In some embodiments, the fluid comprises about 8 wt. % heat capacity enhancer and cavitation stabilizer.

In some embodiments, the fluid comprises a lubricant. In some embodiments, the lubricant comprises mineral oil (e.g., light mineral oil), polyalphaolefins (PAO), an ester (e.g., a synthetic ester), group III base oils, and/or hydrogenated vegetable esters. PAOs are synthetic hydrocarbon base oils produced through the polymerization of alpha-olefin monomers, typically 1-decene. In some embodiments, the lubricant is selected from the group consisting of: mineral oil (e.g., light mineral oil), polyalphaolefins (PAO), an ester (e.g., a synthetic ester), group III base oils, and hydrogenated vegetable esters. In some embodiments, the lubricant comprises mineral oil. In some embodiments, the lubricant comprises light mineral oil. In some embodiments, the lubricant is light mineral oil. In some embodiments, the fluid comprises about 1 wt. % to about 15 wt. % (e.g., about 2 wt. % to 10 wt. %, about 2 wt. % to about 6 wt. %, about 6 wt. % to about 10 wt. %, about 4 wt. % to about 8 wt. %, about 2 wt. %, about 3 wt. %, about 4 wt. %, about 5 wt. %, about 6 wt. %, about 7 wt. %, about 8 wt. %, about 9 wt. %, or about 10 wt. %) lubricant. In some embodiments, the fluid comprises about 2 wt. % to 10 wt. % lubricant. In some embodiments, the fluid comprises about 6 wt. % lubricant.

In some embodiments, the fluid comprises a polar interface modulator and micelle contributor. In some embodiments, the polar interface modulator and micelle contributor comprises oleic acid, ricinoleic acid, stearic acid, a trimethylolpropane ester, and/or a pentaerythritol ester. In some embodiments, the polar interface modulator and micelle contributor is selected from the group consisting of: oleic acid, ricinoleic acid, stearic acid, a trimethylolpropane ester, and a pentaerythritol ester. In some embodiments, the polar interface modulator and micelle contributor comprises oleic acid. In some embodiments, the polar interface modulator and micelle contributor is oleic acid. In some embodiments, the fluid comprises about 1 wt. % to about 15 wt. % (e.g., about 2 wt. % to about 6 wt. %, about 2 wt. % to about 4 wt. %, about 4 wt. % to about 6 wt. %, about 3 wt. % to about 5 wt. %, about 3 wt. %, about 4 wt. %, about 5 wt. %, about 6 wt. %, about 7 wt. %, about 8 wt. %, about 9 wt. %, about 2 wt. %, or about 1 wt. %) polar interface modulator and micelle contributor. In some embodiments, the fluid comprises about 2 wt. % to about 6 wt. % polar interface modulator and micelle contributor. In some embodiments, the fluid comprises about 4 wt. % polar interface modulator and micelle contributor.

In some embodiments, the fluid comprises a viscosity stabilizer and thermal damping modifier. In some embodiments, the viscosity stabilizer and thermal damping modifier comprises glycerol, sorbitol, PEG-400, and/or a polyglycerol. In some embodiments, the viscosity stabilizer and thermal damping modifier is selected from the group consisting of: glycerol, sorbitol, PEG-400, and a polyglycerol. In some embodiments, the viscosity stabilizer and thermal damping modifier comprises glycerol. In some embodiments, the viscosity stabilizer and thermal damping modifier is glycerol. In some embodiments, the fluid comprises about 0.1 wt. % to about 10 wt. % (e.g., about 1 wt. % to about 5 wt. %, about 1 wt. % to about 8 wt. %, about 1 wt. % to about 3 wt. %, about 2 wt. % to about 4 wt. %, about 1 wt. %, about 2 wt. %, about 3 wt. %, about 4 wt. %, or about 5 wt. %) viscosity stabilizer and thermal damping modifier. In some embodiments, the fluid comprises about 1 wt. % to about 5 wt. % viscosity stabilizer and thermal damping modifier. In some embodiments, the fluid comprises about 3 wt. % viscosity stabilizer and thermal damping modifier.

In some embodiments, the fluid comprises a non-ionic surfactant. In some embodiments, the non-ionic surfactant controls emulsion stability. In some embodiments, the non-ionic surfactant comprises sorbitan monooleate, tween 80, modified lecithin, and/or an ethoxylated non-ionic ester. In some embodiments, the non-ionic surfactant is selected from the group consisting of: sorbitan monooleate, tween 80, modified lecithin, and an ethoxylated non-ionic ester. In some embodiments, the fluid comprises about 0.1 wt. % to about 10 wt. % (e.g., about 1 wt. % to about 4 wt. %, about 1 wt. % to about 3 wt. %, about 1 wt. %, about 2 wt. %, about 3 wt. %, about 4 wt. %, or about 2 wt. %) non-ionic surfactant. In some embodiments, the fluid comprises about 1 wt. % to about 4 wt. % non-ionic surfactant. In some embodiments, the fluid comprises about 2 wt. % non-ionic surfactant.

In some embodiments, the fluid comprises a vapor phase accelerator. In some embodiments, the vapor phase accelerator comprises methyl ethyl ketone (MEK), acetone, methyl isobutyl ketone (MIBK), ethyl acetate, and/or diethyl ether. In some embodiments, the vapor phase accelerator is selected from the group consisting of: methyl ethyl ketone (MEK), acetone, methyl isobutyl ketone (MIBK), ethyl acetate, and diethyl ether. In some embodiments, the vapor phase accelerator comprises methyl ethyl ketone. In some embodiments, the vapor phase accelerator is methyl ethyl ketone. In some embodiments, the fluid comprises about 0.1 wt. % to about 10 wt. % (e.g., about 1 wt. % to about 5 wt. %, about 1 wt. % to about 3 wt. %, about 1 wt. % to about 4 wt. %, about 2 wt. % to about 6 wt. %, about 1 wt. %, about 2 wt. %, about 3 wt. %, or about 4 wt. %) vapor phase accelerator. In some embodiments, the fluid comprises about 1 wt. % to about 5 wt. % vapor phase accelerator. In some embodiments, the fluid comprises about 2 wt. % vapor phase accelerator.

In some embodiments, the fluid comprises an antioxidant. In some embodiment, the antioxidant comprises one or more hindered phenols and one or more phosphites. In some embodiments, the antioxidant is one or more hindered phenols and one or more phosphites. In some embodiments, the fluid comprises about 0.001 wt. % to about 5 wt. % (e.g., about 0.001 wt. % to about 2 wt. %, about 0.001 wt. % to about 1 wt. %, about 0.001 wt. % to about 0.8 wt. %, about 0.1 wt. % to about 0.5 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 or about 1 wt. %) antioxidant. In some embodiments, the fluid comprises about 0.001 wt. % to about 1 wt. % antioxidant. In some embodiments, the fluid comprises about 0.3 wt. % antioxidant.

Some embodiments provide a fluid, comprising water and a lubricant.

In some embodiments, the lubricant is selected from the group consisting of: mineral oil, polyalphaolefins (PAO), an ester, group III base oils, and/or hydrogenated vegetable esters.

In some embodiments, the fluid comprises at least one of the following:
(i) a volatility regulator and nucleation enhancer selected from the group consisting of: isopropyl alcohol, ethanol, n-propanol, and t-butanol;
(ii) a heat capacity enhancer and cavitation stabilizer selected from the group consisting of: monoethylene glycol, propylene glycol, diethylene glycol, and triethylene glycol;
(iii) a polar interface modulator and micelle contributor selected from the group consisting of: oleic acid, ricinoleic acid, stearic acid, a trimethylolpropane ester, and/or a pentaerythritol ester;
(iv) a viscosity stabilizer and thermal damping modifier selected from the group consisting of: glycerol, sorbitol, PEG-400, and a polyglycerol;
(v) a non-ionic surfactant selected from the group consisting of: sorbitan monooleate, tween 80, modified lecithin, and an ethoxylated non-ionic ester; and
(vi) a vapor phase accelerator selected from the group consisting of: methyl ethyl ketone (MEK), acetone, methyl isobutyl ketone (MIBK), ethyl acetate, and diethyl ether; and
(vii) an antioxidant comprising hindered phenols and phosphites.

In some embodiments, the fluid comprises at least one of (i)-(vii). In some embodiments, the fluid comprises at least two of (i)-(vii). In some embodiments, the fluid comprises at least three of (i)-(vii). In some embodiments, the fluid comprises at least four of (i)-(vii). In some embodiments, the fluid comprises at least five of (i)-(vii). In some embodiments, the fluid comprises at least six of (i)-(vii). In some embodiments, the fluid comprises (i)-(vii).

In some embodiments, the lubricant is light mineral oil.

In some embodiments, (i) is isopropyl alcohol. In some embodiments, (ii) is monoethylene glycol. In some embodiments, (iii) is oleic acid. In some embodiments, (iv) is glycerol. In some embodiments, (v) is sorbitan monooleate. In some embodiments, (vi) is methyl ethyl ketone (MEK).

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Thus, particular implementations of the subject matter have been described. Other implementations are within the scope of the following claims. Various modifications may be made without departing from the spirit and scope of the disclosure. In some cases, the actions recited in the claims can be performed in a different order and still achieve desirable results. In addition, the processes depicted in the accompanying figures do not necessarily require the particular order shown, or sequential order, to achieve desirable results.

In a first aspect, a fluid comprises water and a lubricant.

In a second aspect according to the first aspect, the water comprises distilled water.

In a third aspect according to the first aspect or the second aspect, the lubricant is selected from the group consisting of: mineral oil, polyalphaolefins (PAO), an ester, group III base oils, and/or hydrogenated vegetable esters.

In a fourth aspect according to any one of the first aspect to the third aspect, the fluid comprises at least one of the following:
(i) a volatility regulator and nucleation enhancer selected from the group consisting of: isopropyl alcohol, ethanol, n-propanol, and t-butanol;
(ii) a heat capacity enhancer and cavitation stabilizer selected from the group consisting of: monoethylene glycol, propylene glycol, diethylene glycol, and triethylene glycol;
(iii) a polar interface modulator and micelle contributor selected from the group consisting of: oleic acid, ricinoleic acid, stearic acid, a trimethylolpropane ester, and/or a pentaerythritol ester;
(iv) a viscosity stabilizer and thermal damping modifier selected from the group consisting of: glycerol, sorbitol, PEG-400, and a polyglycerol;
(v) a non-ionic surfactant selected from the group consisting of: sorbitan monooleate, tween 80, modified lecithin, and an ethoxylated non-ionic ester;
(vi) a vapor phase accelerator selected from the group consisting of: methyl ethyl ketone (MEK), acetone, methyl isobutyl ketone (MIBK), ethyl acetate, and diethyl ether; and
(vii) an antioxidant comprising hindered phenols and phosphites.

In a fifth aspect according to the fourth aspect, the fluid comprises at least one of (i)-(vii).

In a sixth aspect according to the fourth aspect, the fluid comprises at least two of (i)-(vii).

In a seventh aspect according to the fourth aspect, the fluid comprises at least three of (i)-(vii).

In an eighth aspect according to the fourth aspect, the fluid comprises at least four of (i)-(vii).

In a ninth aspect according to the fourth aspect, the fluid comprises at least five of (i)-(vii).

In a tenth aspect according to the fourth aspect, the fluid comprises at least six of (i)-(vii).

In an eleventh aspect according to the fourth aspect, the fluid comprises (i)-(vii).

In a twelfth aspect according to any one of the first aspect to the eleventh aspect, the lubricant is light mineral oil.

In a thirteenth aspect according to any one of the fourth aspect to the twelfth aspect, (i) is isopropyl alcohol.

In a fourteenth aspect according to any one of the fourth aspect to the eleventh aspect, The fluid of any one of claims 1-13, wherein (ii) is monoethylene glycol.

In a fifteenth aspect according to any one of the fourth aspect to the fourteenth aspect, (iii) is oleic acid.

In a sixteenth aspect according to any one of the fourth aspect to the fifteenth (iv) is glycerol.

In a seventeenth aspect according to any one of the fourth aspect to the sixteenth aspect, (v) is sorbitan monooleate.

In an eighteenth aspect according to any one of the fourth aspect to the seventeenth aspect, (vi) is methyl ethyl ketone (MEK).

In a nineteenth aspect according to any one of the first aspect to the eighteenth aspect, the fluid comprises about 55 wt. % to about 70 wt. % water.

In a twentieth aspect according to the nineteenth aspect, the fluid comprises about 60 wt. % water.

In a twenty-first aspect according to any one of the first aspect to the twentieth aspect, the fluid comprises about 2 wt. % to 10 about wt. % of the lubricant.

In a twenty-second aspect according to the twenty-first aspect, the fluid comprises about 6 wt. % of the lubricant.

In a twenty-third aspect according to any one of the fourth aspect to the twenty-second aspect, the fluid comprises about 10 wt. % to about 22 wt. % (i).

In a twenty-fourth aspect according to the twenty-third aspect, the fluid comprises about 14 wt. % (i).

In a twenty-fifth aspect according to any one of the fourth aspect to the twenty-fourth aspect, the fluid comprises about 4 wt. % to about 12 wt. % (ii).

In a twenty-sixth aspect according to the twenty-fifth aspect, the fluid comprises about 8 wt. % (ii).

In a twenty-seventh aspect according to any one of the fourth aspect to the twenty-sixth aspect, the fluid comprises about 2 wt. % to about 6 wt. % (iii).

In a twenty-eighth aspect according to the twenty-seventh aspect, the fluid comprises about 4 wt. % (iii).

In a twenty-ninth aspect according to any one of the fourth aspect to the twenty-eighth aspect, the fluid comprises about 1 wt. % to about 5 wt. % (iv).

In a thirtieth aspect according to the twenty-ninth aspect, the fluid comprises about 3 wt. % (iv).

In a thirty-first aspect according to any one of the fourth aspect to the thirtieth aspect, the fluid comprises about 1 wt. % to about 4 wt. % (v).

In a thirty-second aspect according to the thirty-first aspect, the fluid comprises about 2 wt. % (v).

In a thirty-third aspect according to any one of the fourth aspect to the thirty-second aspect, the fluid comprises about 1 wt. % to about 5 wt. % (vi).

In a thirty-fourth aspect according to the thirty-third aspect, the fluid comprises about 2 wt. % (vi).

In a thirty-fifth aspect according to any one of the fourth aspect to the thirty-fourth, the fluid comprises about 0.001 wt. % to about 1 wt. % (vii).

In a thirty-sixth aspect according to the thirty-fifth aspect, the fluid comprises about 0.3 wt. % (vii).

In a thirty-seventh aspect, an engine system comprises:
an engine comprising an expansion chamber;
a fluid pathway fluidly connected to the expansion chamber and defining a closed loop fluid cycle, the fluid pathway configured to direct the fluid of any one of aspect one to thirty-six to the expansion chamber and from the expansion chamber; and
the fluid disposed in the fluid pathway and comprising distilled water.

In a thirty-eighth aspect according to the thirty-seventh aspect, the engine system further comprising a fluid pump fluidly connected to the fluid cycle, the fluid pump configured to pressurize the fluid in the fluid cycle upstream of the expansion chamber to a minimum pressure threshold.

In a thirty-ninth aspect according to the thirty-eighth aspect, the minimum pressure threshold comprises 2,000 bar.

In a fortieth aspect according to the thirty-seventh aspect, the engine comprises an injector disposed at least partially within the expansion chamber and configured to inject a portion of the fluid into the expansion chamber.

In a forty-first aspect according to the fortieth aspect, the injector comprises an activator in fluid communication with the fluid in the injector, the activator configured to cause the fluid to transition from liquid phase to gas phase.

In a forty-second aspect according to the forty-first aspect, the activator comprises an induction coil configured to heat the fluid to its gas phase.

In a forty-third aspect according to the thirty-seventh aspect, the engine system further comprising a recirculation system fluidly connected to the fluid pathway and comprising a condenser configured to cause the fluid to transition to liquid phase.

In a forty-fourth aspect according to the forty-third aspect, the recirculation system is fluidly connected to the engine to supply the fluid in liquid phase to the engine.

In a forty-fifth aspect according to the thirty-seventh aspect, the engine comprises a plurality of cylinders and a plurality of pistons disposed in the plurality of cylinders, the plurality of pistons and plurality of cylinders defining a plurality of expansion chambers comprising the first-mentioned expansion chamber, the plurality of pistons configured to translate within the plurality of cylinders.

In a forty-sixth aspect, a method for operating an engine comprises:
receiving, at an expansion chamber of an engine, the fluid of any one of aspects one to thirty-six from a fluid pathway;
causing the fluid to transition from liquid phase to gas phase in the expansion chamber;
receiving, at a condenser fluidly connected to the expansion chamber, the fluid from the expansion chamber; and
converting, at the condenser, the fluid into liquid phase.

In a forty-seventh aspect according to the forty-sixth aspect, the fluid pathway defining a closed loop fluid cycle, the method further comprising recirculating the fluid from the condenser toward the expansion chamber of the engine.

In a forty-eighth aspect according to the forty-sixth aspect, the method comprising pressurizing, with a fluid pump fluidly connected to the fluid pathway upstream of the expansion chamber, the fluid in the fluid pathway to a minimum pressure threshold.

In a forty-ninth aspect according to the forty-sixth aspect, receiving the fluid at the expansion chamber comprises injecting, with an injector disposed at least partially within the expansion chamber, a portion of the fluid into the expansion chamber.

In a fiftieth aspect according to the forty-ninth aspect, the injector comprises an activator in fluid communication with the fluid in the injector, and causing the fluid to transition from liquid phase to gas phase comprises causing, with the activator, the fluid to transition from liquid phase to gas phase.

In a fifty-first aspect according to the fiftieth aspect, the activator comprises an induction coil, and causing the fluid to transition from liquid phase to gas phase comprises heating, with the induction coil, the fluid to its gas phase.

In a fifty-second aspect, an engine system comprises an engine comprising a chamber defined at least partially by a cylinder and a piston; and an injector at least partially disposed within the chamber, the injector configured to inject the fluid of any one of aspects one to thirty-six into the chamber and cause a phase transition of the fluid from liquid phase to gas phase.

In a fifty-third aspect according to the fifty-second aspect, the engine system comprises a closed loop fluid cycle, the fluid disposed in the closed loop fluid cycle, and the closed loop fluid cycle to supply the fluid to the injector, receive the fluid from the chamber, and recirculate the fluid back to the injector.

### NUMBERED EMBODIMENTS

Embodiment 1. An engine system, comprising:
an engine comprising an expansion chamber;
a fluid pathway fluidly connected to the expansion chamber and defining a closed loop fluid cycle, the fluid pathway configured to direct a fluid to the expansion chamber and from the expansion chamber; and
the fluid disposed in the fluid pathway and comprising distilled water.
Embodiment 2. The engine system of embodiment 1, further comprising a fluid pump fluidly connected to the fluid cycle, the fluid pump configured to pressurize the fluid in the fluid cycle upstream of the expansion chamber to a minimum pressure threshold.
Embodiment 3. The engine system of embodiment 2, wherein the minimum pressure threshold comprises 2,000 bar.
Embodiment 4. The engine system of embodiment 1, wherein the engine comprises an injector disposed at least partially within the expansion chamber and configured to inject a portion of the fluid into the expansion chamber.
Embodiment 5. The engine system of embodiment 4, wherein the injector comprises an activator in fluid communication with the fluid in the injector, the activator configured to cause the fluid to transition from liquid phase to gas phase.
Embodiment 6. The engine system of embodiment 5, wherein the activator comprises an induction coil configured to heat the fluid to its gas phase.
Embodiment 7. The engine system of embodiment 1, wherein the fluid comprises the distilled water in a concentration of at least 55% by weight.
Embodiment 8. The engine system of embodiment 7, wherein the fluid comprises about 60% distilled water.
Embodiment 9. The engine system of embodiment 7 or embodiment 8, wherein a remainder of the fluid comprises at least one of a fatty acid component, an alcohol component, or a hydrocarbon component.
Embodiment 10. The engine system of embodiment 9, wherein the remainder of the fluid comprises the fatty acid component, the alcohol component, and the hydrocarbon component.
Embodiment 11. The engine system of embodiment 1, further comprising a recirculation system fluidly connected to the fluid pathway and comprising a condenser configured to cause the fluid to transition to liquid phase.
Embodiment 12. The engine system of embodiment 11, wherein the recirculation system is fluidly connected to the engine to supply the fluid in liquid phase to the engine.
Embodiment 13. The engine system of embodiment 1, wherein the engine comprises a plurality of cylinders and a plurality of pistons disposed in the plurality of cylinders, the plurality of pistons and plurality of cylinders defining a plurality of expansion chambers comprising the first-mentioned expansion chamber, the plurality of pistons configured to translate within the plurality of cylinders.
Embodiment 14. A method for operating an engine, the method comprising:
receiving, at an expansion chamber of an engine, a fluid from a fluid pathway, the fluid comprising distilled water;
causing the fluid to transition from liquid phase to gas phase in the expansion chamber;
receiving, at a condenser fluidly connected to the expansion chamber, the fluid from the expansion chamber; and
converting, at the condenser, the fluid into liquid phase.
Embodiment 15. The method of embodiment 14, wherein the fluid pathway defining a closed loop fluid cycle, the method further comprising recirculating the fluid from the condenser toward the expansion chamber of the engine.
Embodiment 16. The method of embodiment 14, comprising pressurizing, with a fluid pump fluidly connected to the fluid pathway upstream of the expansion chamber, the fluid in the fluid pathway to a minimum pressure threshold.
Embodiment 17. The method of embodiment 14, wherein receiving the fluid at the expansion chamber comprises injecting, with an injector disposed at least partially within the expansion chamber, a portion of the fluid into the expansion chamber.
Embodiment 18. The method of embodiment 17, wherein the injector comprises an activator in fluid communication with the fluid in the injector, and
causing the fluid to transition from liquid phase to gas phase comprises causing, with the activator, the fluid to transition from liquid phase to gas phase.
Embodiment 19. The method of embodiment 18, wherein the activator comprises an induction coil, and causing the fluid to transition from liquid phase to gas phase comprises heating, with the induction coil, the fluid to its gas phase.
Embodiment 20. An engine system, comprising:
an engine comprising a chamber defined at least partially by a cylinder and a piston;
an injector at least partially disposed within the chamber, the injector configured to inject a fluid into the chamber and cause a phase transition of the fluid from liquid phase to gas phase; and
the fluid comprising distilled water.
Embodiment 21. The engine system of embodiment 20, comprising a closed loop fluid cycle, the fluid disposed in the closed loop fluid cycle, and the closed loop fluid cycle to supply the fluid to the injector, receive the fluid from the chamber, and recirculate the fluid back to the injector.
Embodiment 22. The engine system of embodiment 20 or embodiment 21, wherein the fluid comprises the distilled water in a concentration of between 55% and 70% by weight.

1. A fluid, comprising water and a lubricant.

2. The fluid of claim 1, wherein the water comprises distilled water.

3. The fluid of claim 1, wherein the lubricant is selected from the group consisting of: mineral oil, polyalphaolefins (PAO), an ester, group III base oils, and/or hydrogenated vegetable esters.

4. The fluid of claim 1, comprising at least one of the following:
(i) a volatility regulator and nucleation enhancer selected from the group consisting of: isopropyl alcohol, ethanol, n-propanol, and t-butanol;
(ii) a heat capacity enhancer and cavitation stabilizer selected from the group consisting of: monoethylene glycol, propylene glycol, diethylene glycol, and triethylene glycol;
(iii) a polar interface modulator and micelle contributor selected from the group consisting of: oleic acid, ricinoleic acid, stearic acid, a trimethylolpropane ester, and/or a pentaerythritol ester;
(iv) a viscosity stabilizer and thermal damping modifier selected from the group consisting of: glycerol, sorbitol, PEG-400, and a polyglycerol;
(v) a non-ionic surfactant selected from the group consisting of: sorbitan monooleate, tween 80, modified lecithin, and an ethoxylated non-ionic ester;
(vi) a vapor phase accelerator selected from the group consisting of: methyl ethyl ketone (MEK), acetone, methyl isobutyl ketone (MIBK), ethyl acetate, and diethyl ether; or (vii) an antioxidant comprising hindered phenols and phosphites.

5. The fluid of claim 4, wherein the fluid comprises all of (i)-(vii).

6. The fluid of claim 4, wherein the fluid comprises (i), and (i) comprises isopropyl alcohol.

7. The fluid of claim 4, wherein the fluid comprises (ii), and (ii) comprises monoethylene glycol.

8. The fluid of claim 4, wherein the fluid comprises (iii), and (iii) comprises oleic acid.

9. The fluid of claim 4, wherein the fluid comprises (iv), and (iv) comprises glycerol.

10. The fluid of claim 4, wherein the fluid comprises (v), and (v) comprises sorbitan monooleate.

11. The fluid of claim 4, wherein the fluid comprises (vi), and (vi) comprises methyl ethyl ketone (MEK).

12. The fluid of claim 4, wherein the fluid comprises about 10 wt. % to about 22 wt. % of (i).

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. An engine system, comprising:
an engine comprising an expansion chamber;
a fluid pathway fluidly connected to the expansion chamber and defining a closed loop fluid cycle, the fluid pathway configured to direct a fluid to the expansion chamber and from the expansion chamber; and
the fluid disposed in the fluid pathway and comprising water and a lubricant.

26. The engine system of claim 25, further comprising a fluid pump fluidly connected to the fluid cycle, the fluid pump configured to pressurize the fluid in the fluid cycle upstream of the expansion chamber to a minimum pressure threshold.

27. The engine system of claim 25, wherein the engine comprises an injector disposed at least partially within the expansion chamber and configured to inject a portion of the fluid into the expansion chamber.

28. The engine system of claim 27, wherein the injector comprises an activator in fluid communication with the fluid in the injector, the activator configured to cause the fluid to transition from liquid phase to gas phase.

29. The engine system of claim 28, wherein the activator comprises an induction coil configured to heat the fluid to its gas phase.

30. The engine system of claim 25, further comprising a recirculation system fluidly connected to the fluid pathway and comprising a condenser configured to cause the fluid to transition to liquid phase, wherein the recirculation system is fluidly connected to the engine to supply the fluid in liquid phase to the engine.

31. The engine system of claim 26, wherein the minimum pressure threshold comprises 2,000 bar.

32. The engine system of claim 25, wherein the engine comprises a plurality of cylinders and a plurality of pistons disposed in the plurality of cylinders, the plurality of pistons and plurality of cylinders defining a plurality of expansion chambers comprising the first-mentioned expansion chamber, the plurality of pistons configured to translate within the plurality of cylinders.

33. The engine system of claim 25, wherein the closed loop fluid cycle to supply the fluid to the expansion chamber, receive the fluid from the expansion chamber, and recirculate the fluid back to the expansion chamber.

34. The engine system of claim 25, wherein the water comprises distilled water.

35. The engine system of claim 25, wherein the lubricant is a member selected from the group consisting of: mineral oil, polyalphaolefins (PAO), an ester, group III base oils, and/or hydrogenated vegetable esters.

36. The engine system of claim 25, wherein the lubricant comprises light mineral oil.

37. The engine system of claim 25, wherein the fluid comprises the water in a concentration of about 55 wt. % to about 70 wt. %.

38. The engine system of claim 37, wherein the fluid comprises about 60 wt. % water.

39. The engine system of claim 25, wherein the fluid comprises the lubricant in a concentration of about 2 wt. % to 10 about wt. %.

40. The engine system of claim 39, wherein the fluid comprises about 6 wt. % of the lubricant.

41. The engine system of claim 25, wherein the fluid comprises at least one of the following:
(i) a volatility regulator and nucleation enhancer selected from the group consisting of: isopropyl alcohol, ethanol, n-propanol, and t-butanol;
(ii) a heat capacity enhancer and cavitation stabilizer selected from the group consisting of: monoethylene glycol, propylene glycol, diethylene glycol, and triethylene glycol;
(iii) a polar interface modulator and micelle contributor selected from the group consisting of: oleic acid, ricinoleic acid, stearic acid, a trimethylolpropane ester, and/or a pentaerythritol ester;
(iv) a viscosity stabilizer and thermal damping modifier selected from the group consisting of: glycerol, sorbitol, PEG-400, and a polyglycerol;
(v) a non-ionic surfactant selected from the group consisting of: sorbitan monooleate, tween 80, modified lecithin, and an ethoxylated non-ionic ester;
(vi) a vapor phase accelerator selected from the group consisting of: methyl ethyl ketone (MEK), acetone, methyl isobutyl ketone (MIBK), ethyl acetate, and diethyl ether; or (vii) an antioxidant comprising hindered phenols and phosphites.

42. The engine system of claim 41, wherein the fluid comprises all of (i) to (vii).
